(19) United States
(12) Patent Application Publication
(10) Pub. No.: US 2023/0334103 A1
(43) Pub. Date: Oct. 19, 2023

(54) SYSTEMS AND METHODS FOR RANKING CHANNEL CONTENT

(71) Applicant: META PLATFORMS, INC., Menlo Park, CA (US)

(72) Inventors: Patrick Joseph Roark Underwood, San Francisco, CA (US); Geoff David Joseph Teehan, Palo Alto, CA (US); George Lewis Kedenburg, III, San Francisco, CA (US); Jason Holland, Mountain View, CA (US)

(21) Appl. No.: 16/361,631

(22) Filed: Mar. 22, 2019

(51) Int. Cl. G06F 16/9538; G06F 16/248; G06F 16/9535; G06Q 50/00; G06F 16/2457

(52) U.S. Cl. CPC G06F 16/9535; G06F 16/24578; G06F 16/248; G06F 16/9538; G06Q 50/01

(57) ABSTRACT

One example computer-implemented method may include (i) maintaining, within an online social network environment, a content channel that defines both which user accounts within the online social network environment have access to the content channel and a sequence for displaying items of social network media content to a user account viewing the content channel, (ii) ranking content channel items by calculating scores for the content channel items indicating an estimated level of priority for displaying the content channel items to the user account, the ranking including at least one of ranking the content channel among at least one other content channel or ranking the items of social network media content within the content channel, and (iii) displaying the content channel items to the user account in an order corresponding to the ranking. Various other methods, systems, and media are also disclosed.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 is a flow diagram of an example method for ranking channel content.

FIG. 2 is a block diagram of an example system for ranking channel content.

FIG. 3 is a block diagram of an additional example system for ranking channel content within a larger network environment.

FIG. 4 illustrates an embodiment of a channels feed that includes one or more content channels.

FIG. 5 illustrates an embodiment of a selected content channel.

FIG. 6 illustrates an embodiment in which a comment is added to a selected content channel.

FIG. 7 illustrates an embodiment in which a private content channel is available for selection.

FIG. 8 illustrates an embodiment in which multiple private content channels are available for selection.

FIG. 9 illustrates an embodiment in which navigation and posting levels are presented together.

FIG. 10 illustrates an embodiment in which additional content channels are posted next to an original post.

FIG. 11 illustrates an embodiment in which multiple posts are contained within a private channel.

FIG. 12 illustrates an embodiment in which a content-specific channel is available for selection.

FIG. 13 illustrates another version of the embodiment of FIG. 9 with additional labeling to highlight how separate content channels may be scored and ranked according to one example system for ranking channel content.

FIG. 14 illustrates another version of the embodiment of FIG. 10 with additional labeling to highlight how separate posts or items of social media content may be scored and ranked according to one example system for ranking channel content.

FIG. 15 illustrates an example workflow for calculating a finalized score for ranking a content channel based on underlying initial scores.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

The present disclosure is generally directed to systems and methods for ranking channel content. The disclosed subject matter may improve upon related systems by leveraging, reengineering, and/or repurposing one or more ranking or recommendation components, including machine learning recommendation components, within the context of an online social network environment, to apply these components newly to content channels and their internal items of social media content.

As further discussed in detail below, these content channels may represent a novel and inventive manner for enabling user accounts to interact with the online social network environment. For example, the content channels may function effectively as separate and independent notifications feeds within the online social network environment, as distinct from a more traditional single and global notifications feed provided to a user account. By way of background, the term “notifications feed” may broadly refer to any feed, in the context of an online social network environment, that sequentially displays, in a calculated order, notifications, posts, post previews, items of multimedia content, and/or items of social media content to one or more browsing user accounts.

Additionally, the content channels may improve upon the traditional single and global notifications feed by enabling users to dynamically and conveniently establish a defined set of user accounts which are permitted to review, interact with, and/or post to the content channels. Moreover, the defined sets of user accounts may dynamically differ and vary between respective different content channels, as discussed in more detail below. In contrast, in a traditional social network environment each user account may only have a single global notifications feed. Moreover, in these traditional systems, each user account may only have limited functionality in terms of potentially preventing a posted item of social media content from appearing in the single global notifications feed of another user account. Accordingly, in these traditional systems each user account does not have the ability to establish a multitude of different content channels and separately establish a strictly defined set of user accounts for each content channel with corresponding access privileges for interacting with these different content channels.

Furthermore, the content channels may improve upon the traditional single global notifications feed by enabling users to scroll through substantially full-screen displays of posts within each one of the content channels rather than simply scrolling up and down through a higher level overview, as with the traditional single and global notifications feed. Moreover, because the content channels may function effectively as separate and independent notifications feeds within the online social network environment, this environment may also provide a graphical user interface (e.g., a content channel feed interface) to view graphical elements, tiles, previews, and/or other graphical indicators for each one of multiple content channels, thereby enabling the user to select which one of the content channels to scroll through or otherwise interact with. In contrast, the traditional online social network environment may only provide a single notifications feed to a corresponding user account, without enabling the user account to select between separate and independent notifications feeds.

Lastly, although some online networks, such as mass video distribution networks, may provide channels in the form of sequential displays of video content, the content channels discussed herein may improve upon these traditional mass video distribution channels in a variety of ways. For example, mass video distribution networks typically limit the primary format for each video page within a channel to providing a large video screen display for corresponding video, as well as optionally one or more fields for user comments, internal links to other videos within the same mass video distribution network, and/or advertisements, etc. Furthermore, the content channels described further below may optionally include mixed-media formats, such that the content channels indicate a sequence of different items of social media content, yet various different ones of these items of social media content may have substantially different multimedia formats. For example, one of the items of social media content may be a substantially pure text post in the form of a status update, whereas the next one in the sequence of the items of social media content may be a substantially pure picture post and/or video post, etc. In other words, even though traditional mass video distribution networks may include some form of conventional channels, these channels have no capability for displaying online social networking textual status updates and/or photograph updates, or otherwise displaying items of social media, within the corresponding sequence of these channels, as distinct from traditional video landing pages.

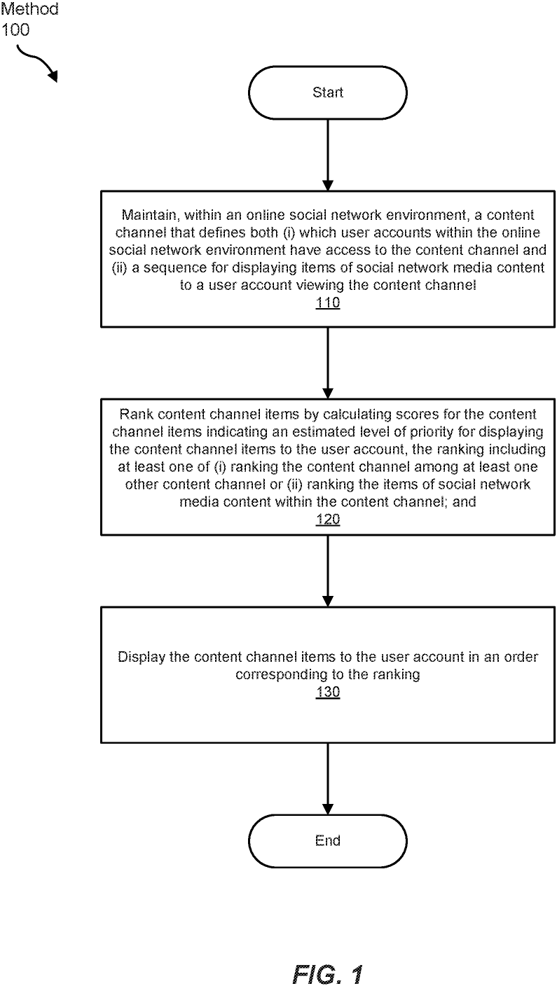

As a more specific example, although traditional mass video distribution networks may allow user accounts to establish channels and may allow other friendly user accounts to post comments to videos within these channels, the other user accounts traditionally cannot post their own videos (or other mixed social media content uploads) to the same channels. Instead, these other user accounts are traditionally limited to consuming video content and commenting on it. Moreover, traditional mass video distribution platforms do not typically enable channel creators to strictly define a set of contacts within these platforms with access privileges to viewing or consuming the corresponding video channels. Accordingly, any browsing user may generally view any published video content as long as the browsing user possesses a corresponding network address, such as a uniform resource locator (e.g., a public or private uniform resource locator), directed to the video content, regardless of whether the browsing user follows the creator of the video channel as a unidirectional contact, regardless of whether the creator of the video channel approves or reciprocates a friendship or contact relationship with the browsing user (e.g., a bidirectional and reciprocal friendship relationship), and even regardless of whether the browsing user has even registered a user account with the mass video distribution platform. The disclosed subject matter may also improve upon related systems in a variety of other ways, which are discussed in more detail below in the corresponding discussions of FIGS. 1-3.

FIG. 1 is a flow diagram of an example computer-implemented method 100 for predictively generating digital suggestions for channel content. The steps shown in FIG. 1 may be performed by any suitable computer-executable code and/or computing system, such as the systems described herein. In one example, each of the steps shown in FIG. 1 may represent an algorithm whose structure includes and/or is represented by multiple sub-steps, examples of which will be provided in greater detail below.

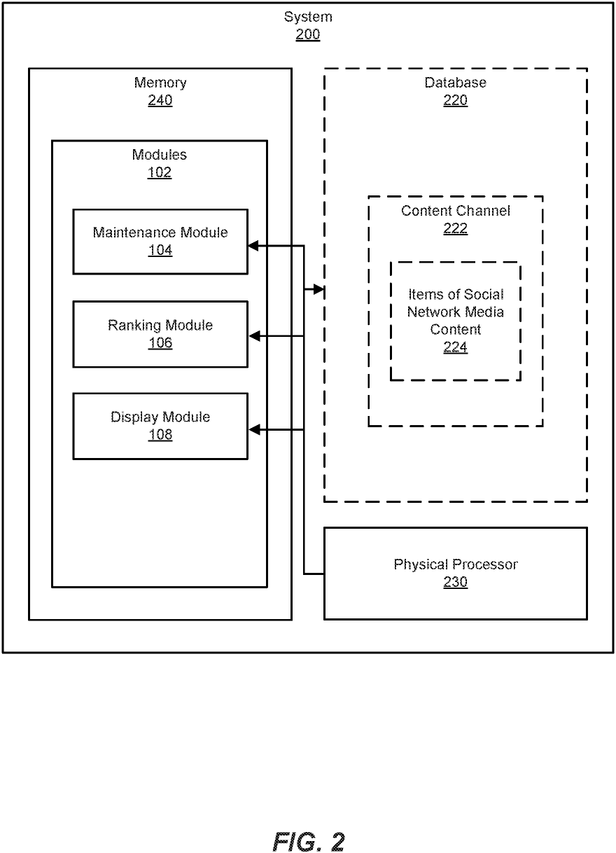

In one embodiment, the steps shown in FIG. 1 may be performed by modules, such as modules 102 as part of system 200 in FIG. 2. Modules 102 may include a maintenance module 104, which may perform step 110 of method 100, a ranking module 106, which may perform step 120 of method 100, and a display module 108, which may perform step 130 of method 100. FIG. 2 also further illustrates how these modules 102 of system 200 interface with a content channel 222 and/or items of social network media content 224, which may correspond to items of information stored within a physical memory 240 in connection with the physical processor 230. Illustrative details of how modules 102 may perform each of the steps of method 100 will be described in more detail below. Moreover, additional details of physical memory 240 and physical processor 230 will be provided after the detailed discussion of method 100.

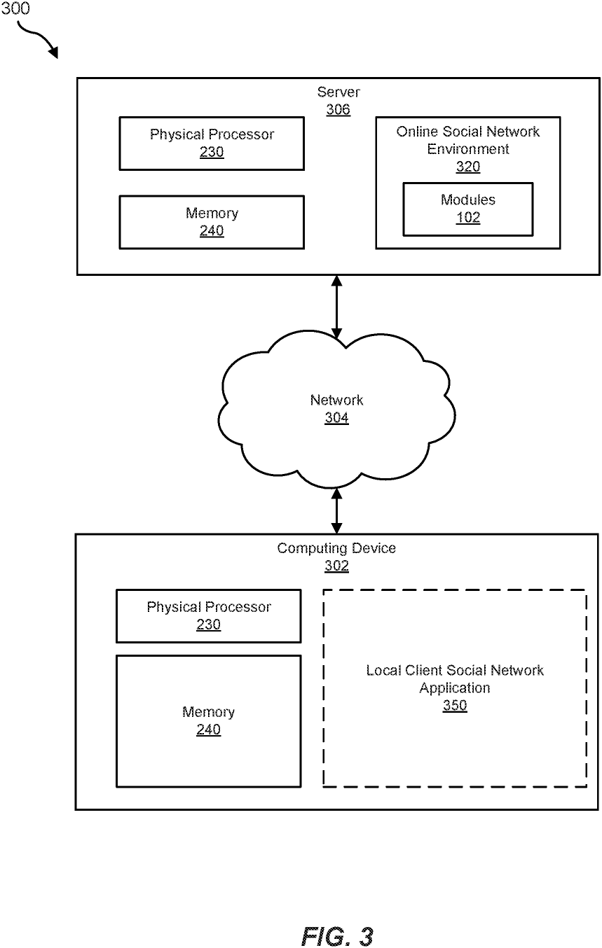

FIG. 3 shows an additional example system 300, within a larger networking context, in which case modules 102 operate within a server 306. Server 306 may correspond to a backend server of a social networking platform and may provide a corresponding online social network environment 320. In these examples, client end users may generally interface with server 306 over a network 304 using one or more computing devices 302. Computing device 302 may represent any type or form of computing device that is capable of reading computer-executable instructions. For example, computing device 302 may represent a user device such as a smartphone and/or a tablet. Additional examples of computing device 302 may include, without limitation, laptops, desktops with mobile elements, wearable devices, personal digital assistants (PDAs), etc. In some examples, a user of computing device 302 may have a user account with online social network environment 320 and may possess an instance of a local client social network application 350, which interfaces with online social network environment 320. For example, local client social network application 350 may be installed on computing device 302. In these examples, the steps shown in FIG. 1 may be performed by modules operating in coordination with the network connection between server 306 and computing device 302. Moreover, although the example of FIG. 3 shows modules 102 as residing within server 306, in additional or alternative examples, any suitable permutation of one or more of modules 102 may optionally be located within computing device 302 instead, thereby providing client-side functionality (e.g., the exact location of the modules is relatively less important in connection with the performance of method 100, because any one or more of these modules may transmit the results of their operations across one or more network connections from a proxy-side or client-side network node). Furthermore, although display module 108 may optionally be located at server 306 rather than computing device 302, display module 108 may effectively perform step 130 of method 100 by directing the display of one or more items of information, such as by providing the information across a corresponding network connection for display at a display of computing device 302, as discussed in more detail below.

Returning to FIG. 1, at step 110, one or more of the systems described herein may maintain, within an online social network environment, a content channel that defines both (i) which user accounts within the online social network environment have access to the content channel and (ii) a sequence for displaying items of social network media content to a user account viewing the content channel. For example, as illustrated in FIG. 3, maintenance module 104 may maintain, within online social network environment 320, content channel 222 that defines which user accounts within online social network environment 320 have access to content channel 222. Moreover, in these examples, content channel 222 may also define a sequence for displaying items of social network media content 224 to the user account viewing content channel 222.

Maintenance module 104 may maintain the content channel in a variety of ways. In some examples, the content channel may include a container within the online social network environment. In other words, the content channel may correspond to a software container that encapsulates a sequence of other items of social network media content, such as posts, photographs, videos, animations, and/or corresponding comment feeds. Furthermore, the software container may also encapsulate, or otherwise store as a data structure, one or more items of information or policies defining which user accounts have access privileges for interacting with the content channel and/or what the various specifics of these access privileges may be (e.g., read access, read-write access, commenting access, posting or publishing access, etc.). Moreover, although traditional notifications feeds might provide a kind of container for similar items of social network media content, the content channels described herein may potentially be separate and independent from each other, such that the same user account can create a multitude of different ones, with different sets of user access privileges between different content channels, as further discussed above.

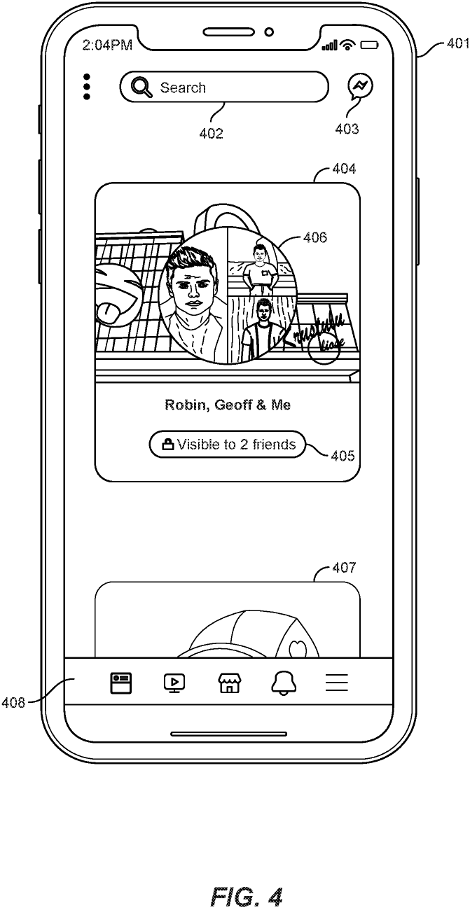

In some examples maintenance module 104 may provide multiple content channels including content channel 222. Moreover, in these examples, maintenance module 104 may optionally provide an interface for the user account to scroll through graphical elements, tiles, previews, or posts respectively indicating the multiple content channels. Furthermore, in these examples, maintenance module 104 may also optionally provide an interface that enables the user account to select the content channel from among multiple contact channels by interacting with a respective one of the graphical elements. Of course, in all the discussions of FIGS. 4-12, maintenance module 104 may perform any one or more of these maintenance features at least in part by interacting with display module 108 to display one or more features of content channels within the display of a computing device such as computing device 302.

Additionally, in some examples these content channels may be automatically generated and/or may be automatically aggregated. For example, one type of content channel may focus on content regarding a trending event (e.g., a current political movement). Additionally, or alternatively, another type of content channel may focus on content regarding a certain conversation topic or a consumer-centric topic (e.g., collecting shoes as a hobbyist). Furthermore, another type of content channel may focus on a topic relating to a specific location (e.g., San Francisco). These types of content channels are merely illustrative. In other examples, a content channel may focus on content regarding any other defined topic (e.g., items of content highlighted by friends of a user within social media, the weather this weekend, other topics that are trending within social media, etc.).

As a more specific example of the embodiment outlined above, as shown in FIG. 4, maintenance module 104 may further provide a user interface 401, which may allow users to view and interact with content channels. For example, a content channel 404 may belong to a user account who created the content channel and may be viewed by the same user account. Additionally, or alternatively, in other cases, content channel 404 may belong to another user account that may also be viewed by a distinct browsing user account. FIG. 4 also further illustrates how a corresponding channel card for content channel 404 or channel intro screen may include various user interface elements including indicators and interaction elements. These indicators may include an image or other background potentially taken from all or a portion of a post within the content channel. In FIG. 4, for example, an audience indicator 406 may be shown over the background image of content channel 404 and may itself show the images (or other representations) of those members that are allowed to access content channel 404. In FIG. 4, content channel 404 is open to Robin, Geoff, and the channel creator.

In addition to the elements described above, another indicator 405 in FIG. 4 may be presented indicating a general number of people that the channel is available to without necessarily specifying who those people are. Accordingly, in these examples, display module 108 may optionally display, in the form of indicator 405 or another indicator listing user accounts with access rights, a clear visual indication of which user accounts within the online social network environment have access to the content channel. Providing the clear visual indication of which user accounts have access to the content channel may thereby inform the creating user account or browsing user account about potential privacy implications of publishing content to the content channel (e.g., prior to actually submitting or posting content to the content channel, a user account may benefit from a clear indication of who will actually have access to, or potentially consume, this content).

In some examples, maintenance module 104 may maintain the content channel at least in part by requesting, upon detecting that a creating user account is attempting to create the corresponding content channel, for the creating user account to specify which user accounts within the online social network environment have access to the content channel. Accordingly, after the creating user account specifies which specific user accounts within the online social network environment will have access to the content channel, display module 108 may optionally display an indicator, such as indicator 405, which provides a visual indication corresponding to the defined set of user accounts to which the creating user account granted access privileges, as further discussed above.

User interface 401 may also provide a search capability 402 that allows users to search through a store of data channels or search through a specific user’s content channels (e.g., the user account’s content channels). The comment icon 403 of user interface 401 may allow users to add comments to a channel or to a post. From user interface 401, users may also be able to navigate to other channels. For instance, the user may scroll down to view the channel preview (or “channel card”) for an additional content channel 407. By selecting a given channel preview, the viewing user account may see individual posts within that content channel. Thus, as noted above, at least three different hierarchical user interface levels may be at play in any given implementation: a channel feed level that shows multiple different channel preview cards, potentially created by different users, a channel overview level that shows individual posts within a given channel, and a post view level that shows the individual post (e.g., an image, video, web page, text blurb, or other content). Various user interface menus and elements may be added or removed dynamically from the user interface 401 as the user moves up or down the hierarchical levels. For instance, an interaction interface 408 may be shown at the channel feed level illustrated in FIG. 4 but may be removed or replaced with a different user interface element at the channel overview level or at the post level. Navigation between the levels may also vary depending on which hierarchical level the user is currently viewing.

Maintenance module 104 may also publish a generated content channel so that the content channel is available for access by specified audience members. For example, maintenance module 104 may be configured to take a content channel that was generated by a content channel generator and make it available on a given platform or internet address. Maintenance module 104 may also make the content channel available to those audience members designated by the user account which created the content channel. These audience members may then interact with the content channel through an interaction interface. The interaction interface may allow the audience members to add new content (e.g., videos, text, pictures, etc.) or add reactions to the user’s posts including comments, stickers, video replies, etc. Upon receiving these audience inputs, maintenance module 104 may apply the changes noted in the inputs to the published content channel. In this manner, a user account can create a content channel, select audience members, make the content channel available to those users, and may then allow those users to add content and/or commentary to the content channel.

In some cases, the initial creator of the content channel may not only provide to maintenance module 104 an indication of the content type of the channel, along with indicating the audience for the content channel but may also provide an indication of capabilities that the generated content channel is to have. In such cases, the content channel may be generated according to the designated content type, the designated audience members, and/or the designated capabilities, as indicated by the creating user account. If the creating user account wants to make changes to any of these items at a later time, the user account may provide an update to server 306, and maintenance module 104 may update the content channel accordingly. The content channel may have various capabilities including the ability to accept video replies from audience members, the ability to notify audience members of new postings or certain types of postings, the ability to add stickers or emojis to posts, the ability for audience members to add their own posts to the user’s channel, the ability for audience members to add their own subchannels to the content channel, or other capabilities. Each capability may be assigned individually to each content channel. In some cases, a default set of capabilities may be applied to new channels, but these capabilities may be changed at a later time by a corresponding user account such as the creating user account.

In some embodiments, the content channel may be made available by maintenance module 104 to the audience members on a pull basis. As such, each audience member may control which content channels and which posts they view within the channels. Each audience member may have their own channel feed view in which they can see both channels that they created/maintained and/or channels created/maintained by other user accounts. This view may be provided in a smartphone application, in a website, in a desktop computer application, or in some other interface. This channel feed view may be populated with channels to which the user account has access. These content channels may be provided to the user account on a pull basis. As such, browsing user accounts may view those channels that they are interested in and may not necessarily see the other content channels. In this manner, posting user accounts may not need to worry about over-posting since other user accounts may optionally only pull the content that they want to see. In other embodiments, a browsing user account may see channel cards for corresponding content channel, such as content channel 404 shown in FIG. 4, but the browsing user account may not necessarily see any related content (e.g., posts) unless the browsing user account selects a particular content channel and thereby pulls content down from the selected content channel to computing device 302.

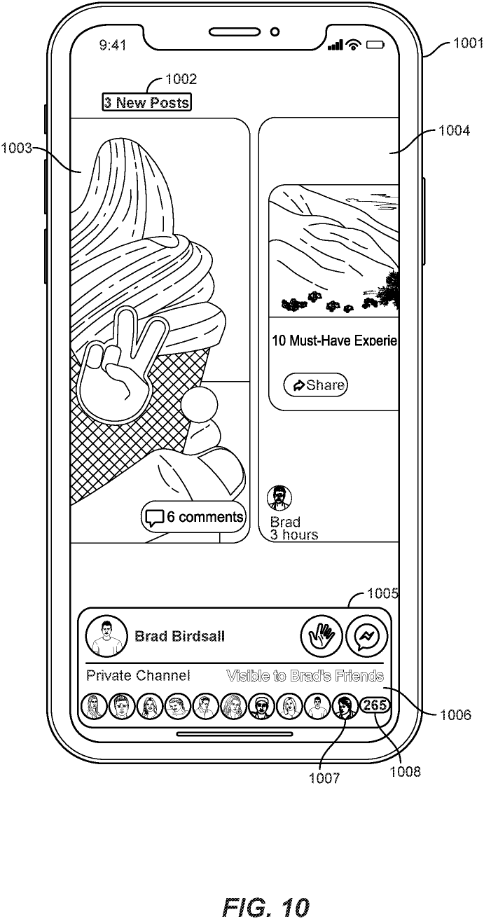

As shown in FIG. 4, maintenance module 104 may present the published content channel with an indication of who the channel is made available to in a context area of the content channel. For example, in FIG. 4, an indicator 405 may show that the content channel is available to two friends. Moreover, as further discussed above, audience indicator 406 may show images or representations of those user accounts. In the embodiment shown in FIG. 4, these indicators are shown directly over the channel card for content channel 404. In other embodiments, such as in FIG. 10, the indicator of who is in the audience for that channel may be at the bottom of the display. For example, the indicator 1006 of FIG. 10 may indicate that the corresponding content channel is private and is available to 265 of the user account’s friends. Images or representations of at least some of the user account’s friends may be illustrated at action interface 1007, along with an indicator 1008 illustrating the number of other people in the audience. In cases where the content is open to the public, the various indicators (e.g., 405 of FIG. 4) may indicate that the content channel is an open channel and is thus visible to the public at large. In cases where the channel is open to the public, a representation of persons may not be shown and, in its place, an “open” graphic may be shown.

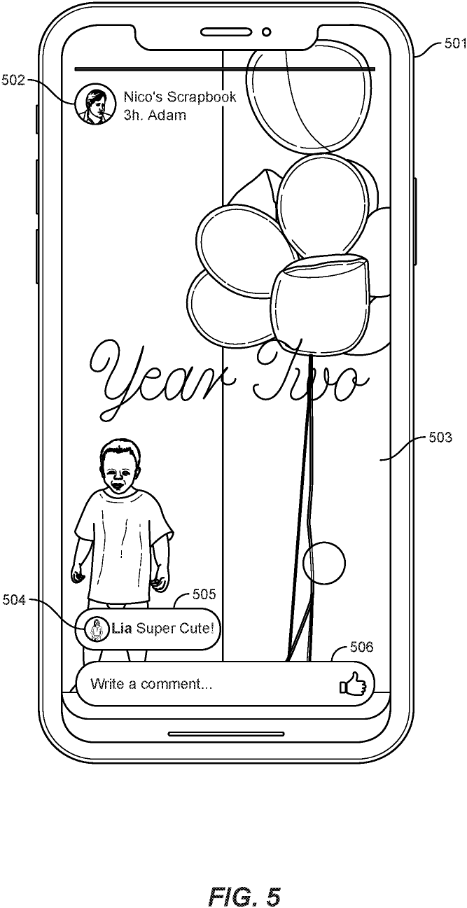

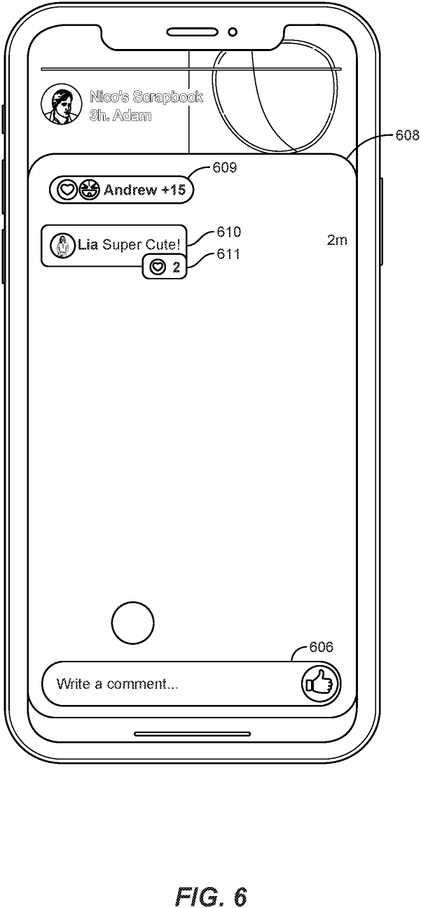

FIG. 5 illustrates an embodiment of a smartphone whereby maintenance module 104, through interfacing with local client social network application 350, presents a user interface 501 that illustrates a post from Nico’s Scrapbook (as indicated at icon 502). In this embodiment, Nico may be the creator of the post. The post may include a photo, text, and potentially other information. A comment bar 506 may be provided which may allow viewing user accounts to write comments about the post or reply to the post in some other manner. At least some of the comments may be illustrated directly over the post as shown with comment 505. The comment may include an indication 504 of who wrote the comment. Some comments may be shown directly with the underlying post 503, while other comments may be illustrated on a separate interface as shown in FIG. 6.

FIG. 6 illustrates a comment interface 608 whereby maintenance module 104 presents one or more comments related to the post previously shown in FIG. 5. In some cases, comment interface 608 may be superimposed over this specific post. Comment interface 608 may provide a user interface indicator 609 of those user accounts which have liked, laughed at, commented upon, or otherwise reacted to the post. In more specific examples, user interface indicator 609 may provide an indication of one or more names of the users who reacted as well as an indication of the overall number of people that have reacted to the post. Comment interface 608 may also show one or more of the comments related to the post. For example, Lia’s comment 610 may be shown in comment interface 608 as well as over the main post. Comment interface 608 may further illustrate an indicator 611 that shows a number of likes or other reactions to a given comment. In at least some embodiments, any posts or comments placed in the published content channel may stay in the published content channel and may be available solely to audience members that have access to the communication space within that channel. As such, user accounts may create posts, leave comments, or otherwise interact with a particular post without worrying that the outside public will see the content. Only those specified members of the audience may be able to view and interact with the specified content channel.

In some embodiments, comment bar 606 of FIG. 6 may be referred to as a “conversation tray.” This conversation tray may be presented at any level including the channel feed level, at the channel level, and/or the post level. The conversation tray in the form of comment bar 606 may allow users to provide comments to different channels or to different individual posts. The conversation tray may be presented at the bottom of the user interface, at the top of the user interface, or at another location within the user interface. In some embodiments, selecting comment bar 606 may open up comment interface 608 shown in FIG. 6.

In at least some embodiments, comment interface 608 may be configured to present a most relevant comment at the top, above the other comments. For example, maintenance module 104 may determine which of the posted comments is most relevant to the user account (i.e., the creator of the channel or post) and then move that comment to the top of comment interface 608. Relevance to the user may be determined based on who gave the comment (e.g., whether it was a family member, a close friend, a person the user has had little interaction with, etc.), based on which comment has received the most reactions, based on which comments the creating user account liked or otherwise reacted with, based on which comment is trending higher based on views or likes, based on which comment mentions the creating user account by name, or based on other factors.

Maintenance module 104 may manage comments that are determined to be most relevant to the creating user account in a variety of different manners. In some examples, comments may be highlighted in bold, in italics, in larger font, in different colored text, or with a color-highlighted background. Highly relevant comments may also be promoted to the top of the comment list so that they are most likely to be seen by the creating user account and by other audience members. The creating user account may specify, using one or more settings or policies, how these highly relevant comments are to be presented. The settings may apply to a particular content channel, to all of the user account’s content channels, to a particular post in a content channel, or to all the posts in a content channel. As such, the creating user account may have a great deal of control over how comments (e.g., particularly highly relevant comments) are presented relative to their corresponding content channels and posts.

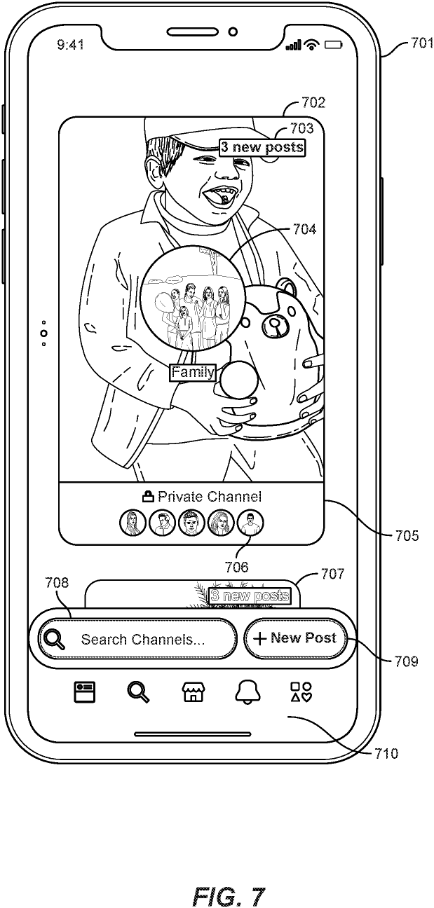

In some embodiments, as illustrated in FIG. 7, maintenance module 104 may be configured to generate (e.g., in coordination with display module 108) a preview for a published content channel. The preview may be the same as or different than the channel cards described above (e.g., the channel card for content channel 404 of FIG. 4). The preview may include a representative portion of media content that is illustrated within a user interface 701. This media content may be a photo such as the photo the user account is starting the channel with. Alternatively, the media content may be a portion of text, or a link to a website, or an image of a movie that the group is planning to watch, etc. As shown in FIG. 7, a preview or channel card 702 may be illustrated with a picture of a boy holding a stuffed bear. Channel card 702 may include an indicator 703 showing how many posts are included in this content channel. The channel card may also include an indicator 705 indicating that the channel is private and is open to family (shown in image 706, for example). As such, it may be immediately apparent who has access to the content channel and who will see the associated posts and comments. Other channel cards may also be shown in this channel feed view, including a channel card 707. While in this channel feed view, user accounts may be able to search through the content channels available to them using interface 708. Browsing user accounts may also be able to create new posts using a graphical button 709 or even create new content channels. Browsing user accounts may also use other interaction elements 710 to interact with the content channels or individual posts.

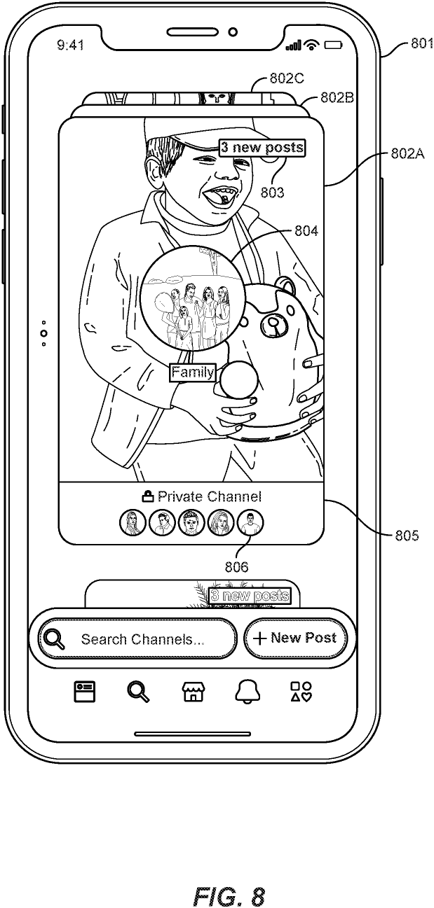

Turning now to FIG. 8, an embodiment is illustrated in which maintenance module 104 may provide access to, or management of, multiple published content channels in a user interface 801 using content channel previews. In FIG. 8, at least some of multiple content channel cards may be shown one behind the other. For instance, channel cards 802A, 802B, and 802C may have each been generated by the same user account. As such, channel cards may show up in a channel feed as appearing one on top of the other. Other channel cards may also be visible in the channel feed. If a browsing user account selects a top channel card in a stack of channel cards, the user account may optionally be navigated to the first content channel in the group of content channels. In some embodiments, an indicator 803 may be provided noting how many new posts are available in the corresponding content channel. In some cases, a similar indicator may be used to note how many content channels are new as well. An indicator 804 may show an image indicating who the content channel (or group of content channels) is open to, while an indicator 805 may show the content channel’s status as being private or open and, if private, showing representations 806 of at least some of the members permitted to see the corresponding content channel or content channels. Thus, when scrolling through a content channel feed of multiple different content channels, a user account may see single channel cards or groups of two or more channel cards stacked on top of each other. The grouped channel cards may be grouped vertically, as shown in FIG. 8, or may be grouped horizontally or in some other manner (e.g., arranged in a square with four channel cards in each corner of the square).

As noted above, many different user accounts may create many different content channels. User accounts may also select which content channels they want to view (from among those content channels that are available to that user account). Each user account may select to follow individual content channels, groups of content channels, all content channels of a given user account, or only some content channels of a given user account. When the content channels are published and made available on a content platform such as a smartphone application or website or desktop application, user accounts may be able to browse the content channels and associated posts at different hierarchical levels as further discussed at length above.

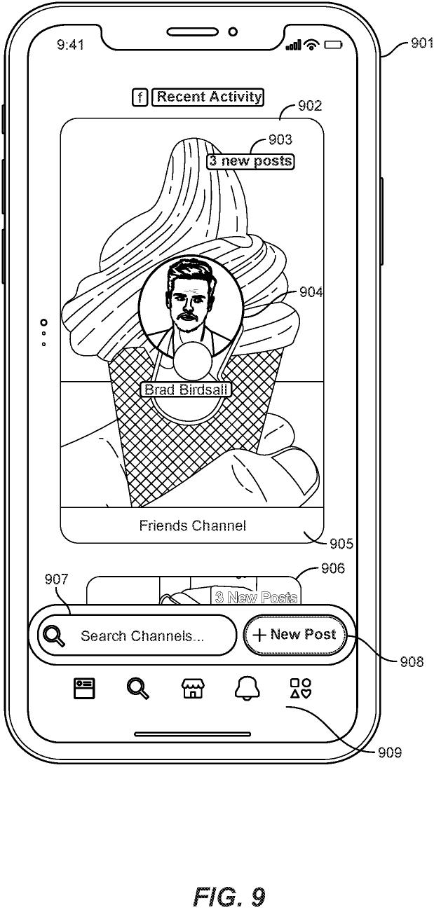

As shown in FIG. 9, multiple content channels (represented by channel previews) may be shown in a channel feed view 901. At the channel feed level, a smartphone corresponding to computing device 302 may illustrate channel cards 902 and 906, along with potentially other content channel cards (or groupings of channel cards such as 802A-802C of FIG. 8). A browsing user account may be able to scroll through a feed of different content channels and select which content channels the user account wishes to view. The selection may be performed via touch selection, voice command, or some other means of interaction with a user interface corresponding to channel feed view 901. An indicator 905 may indicate that the content channel for channel card 902 is open to the channel creator’s friends. An indicator 904 may identify the creator of the content channel (e.g., “Brad Birdsall”) and may show an image or representation of the creator. Other interaction interface elements may include a search bar 907, a new post button 908 and an array of other interaction elements 909 that allow a browsing user account to interact with the content channels and/or associated posts. If a user account selects the content channel for channel card 902, then the user account may be taken to a channel overview level (e.g., as further discussed below in connection with FIG. 10) which may show multiple posts by the channel creator (e.g., Brad Birdsall). In view of the above, channel feed view 901 may correspond to a meta-news-feed, because it effectively corresponds to a notifications feed in which different previews, panels, tiles, icons, and/or slides themselves, upon selection, lead to underlying notifications feeds in the form of content channels, as further discussed above.

In some examples, maintenance module 104 may maintain the content channel at least in part by enabling (e.g., in coordination with display module 108) the user account to scroll through the sequence for displaying items of social network media content. Even more specifically, maintenance module 104 may optionally enable the user account to scroll through the sequence by manually dragging a string of tile graphical elements that each correspond to a respective one of the items of social network media content. Additionally, or alternatively, maintenance module 104 may enable the user to scroll through the sequence by swiping a substantially or partially full-screen display of each respective one of the items of social network media content to navigate to a next display within the sequence.

FIG. 10 provides a more concrete and detailed illustration of the channel overview embodiment outlined above. The channel overview level of FIG. 10 may show different posts within the user account’s content channel including a post 1003 and a post 1004, among others. The browsing user account may interact with each post separately or may interact with multiple posts at once (e.g., liking multiple posts simultaneously within the content channel). The browsing user account may optionally select a post from within the overview level and view that post individually and interact with the post individually (as in FIG. 5). From within a channel overview 1001, the browsing user account may also see an indication 1002 of how many new posts are available within the corresponding content channel and a further indication 1006 of who can see the posts (e.g., post 1003 and post 1004). An indicator 1006 may indicate that the content channel is private and that it is visible to Brad’s friends. Additionally, an indicator 1008 may indicate that the posts in this content channel are visible to 265 friends of Brad, some of which may be shown in the interaction interface 1007. Various other user interface elements 1005 may allow the user to interact with post 1003 and post 1004 in different manners including liking the posts and providing a text-based or video-based response.

In this manner, maintenance module 104 may maintain content channels on at least two different hierarchical levels including the channel feed level and the channel overview level. From within the channel feed level, the user account may select a content channel to view, and from within the channel overview level, the user account may select a post to view. At each hierarchical level, the user account may be able to interact with the channel and/or with the post in different ways, each of which may be configurable in policies. In some embodiments, a browsing user account may only be able to respond to a given post (e.g., by viewing and writing comments or responses to comments) at the post level. In other embodiments, users may be able to respond to posts from within the channel overview level or even potentially to themselves publish additional posts in the sequence of the content channel.

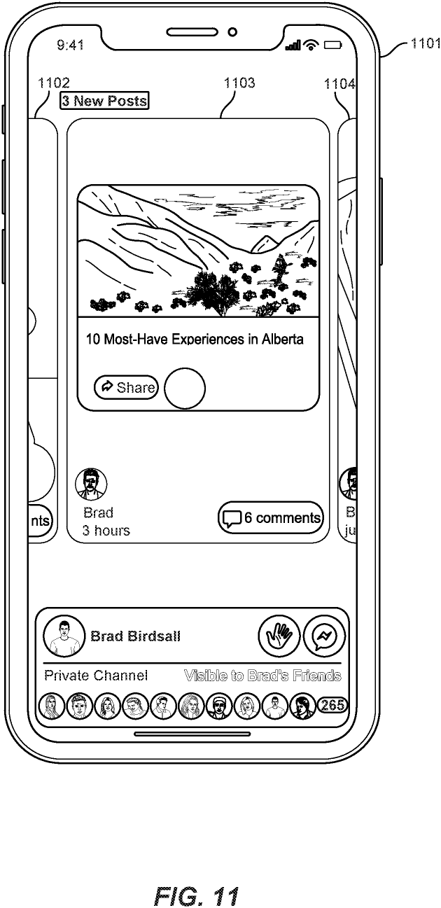

FIG. 11 illustrates an embodiment in which a browsing user account may scroll through different posts within a content channel. For instance, a previously-viewed post may be partially shown (e.g., post 1102), a currently-viewed post may be fully shown (e.g., post 1103), and a previewed post may be partially shown on the other side of the currently-viewed post (e.g., 1104) within a user interface 1101. In this manner, a browsing user account may scroll through different posts within a content channel, dive in to selected posts and interact with those posts, and then pop back out to the channel overview level to scroll through the other posts in that channel. In some embodiments, the user interface 1101 may allow users to navigate from a published content channel to another content channel from any of the hierarchical navigation levels including the channel feed level, the channel overview level, or the post level. In such cases, the interaction interface may include a command or a button or other user interface element that may allow the browsing user account to go to a specified channel or simply go to the next content channel among those to which the user account is subscribed. As such, the browsing user account may be able to efficiently navigate between content channels without having to go up to the feed level and then back down to the channel overview level to view each content channel.

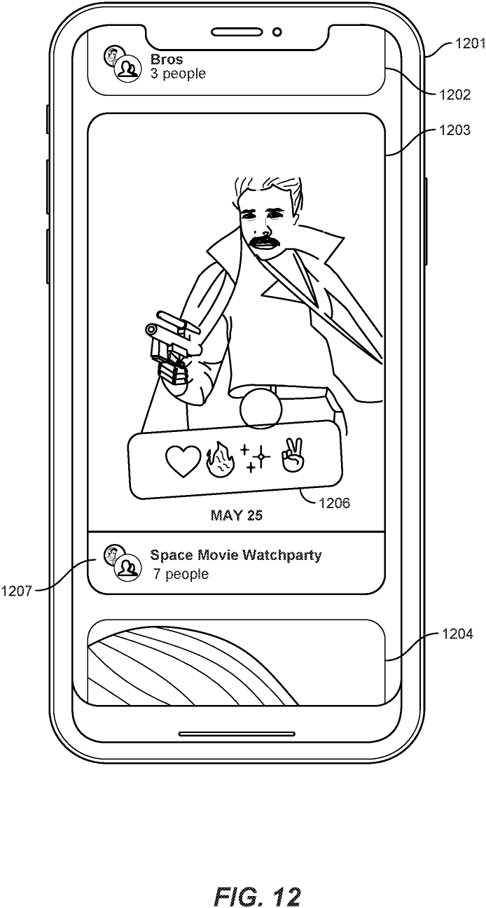

FIG. 12 illustrates an embodiment in which the content channel is of a specified type, namely a watch party. Many different types of channels may be pre-generated by maintenance module 104 with different formatting suitable to respective types of content. Content channels generated for a watch party, for example, may include an interaction interface 1201 with a channel card 1203 (e.g., a content channel preview) representing the movie or television show that is to be watched by the group (e.g., a space movie in the example of FIG. 12). Channel card 1203 may provide an indication of date and time, as well as an indication 1207 of who is coming and other user content such as stickers and likes shown in elements 1206. Thus, in one embodiment, a user account may be browsing through content channels in a channel feed view and, after seeing a channel card 1202, and before seeing a channel card 1204, may see channel card 1203 for the watch party. The user account may, if interested, select channel card 1203 and join the watch party. Many different types of pre-generated content channels are possible and each may have pre-specified formatting types, images, color schemes, layouts, or other content specifications. Some content channels (e.g., family and friends channels) may be more photo- and video-based, while other content channels (e.g., large news channels) may be more text-based. Each content channel creator may decide how they prefer their corresponding content channel to appear and what type of content will be on their content channel.

Thus, in the manner outlined above, different user accounts may create their own content channels from scratch or alternatively use pre-made templates to quickly create their own content channels of a specified type. When creating content channels, the user accounts do not need to worry about who is able to view their channels or posts, as this item of information may be prominently displayed for each content channel and/or each post. Moreover, different user accounts do not need to worry about flooding other user accounts’ feeds with content that these other user accounts do not want. Rather, browsing user accounts may pull down only the content they have selected and chosen to view. Still further, user accounts may be able to easily navigate between different content channels in a channel feed view and navigate between different posts within a channel in a channel overview level. Browsing user accounts may also be able to provide comments and other reactions to content channels and posts in a more intuitive manner at each hierarchical level.

Returning to FIG. 1, at step 120, one or more of the systems described herein may rank content channel items by calculating scores for the content channel items indicating an estimated level of priority for displaying the content channel items to the user account. In these examples, the ranking may include (i) ranking the content channel among at least one other content channel and/or (ii) ranking the items of social network media content within the content channel. For example, as illustrated in FIG. 3, at step 120 ranking module 106 may rank content channel items, which may correspond to content channel 222 and/or items of social network media content 224, at least in part by calculating scores for the content channel items indicating an estimated level of priority for display module 108 to display the content channel items to the user account. Moreover, the term “content channel items” may generally refer to either content channels themselves or individual posts (e.g., items of social network media content) that are internal to content channels or candidates for membership within content channels. In additional or alternative examples, the term “content channel items” may optionally refer to other sub-features or graphical elements relating to the content channels described herein.

Ranking module 106 may rank the content channel items in a variety of ways. For example, ranking module 106 may optionally rank the content channel among at least one other content channel at least in part by ranking a profile content channel for the user account as having the highest rank among the ranking performed at step 120. Returning to the example of FIG. 10, this figure may illustrate the channel overview embodiment of a content channel for the user “Brad Birdsall.” As further discussed above, this provides a channel overview of a corresponding content channel created by this specific user account. In further examples, the content channel for a user account such as “Brad Birdsall” may correspond to a profile content channel for the user account. For example, the content channel may be automatically created for the user account as corresponding to the traditional user profile landing page within the online social network environment. In other words, the profile content channel may correspond to a single basic content channel for a respective user account, analogous to the traditional user profile landing page. Accordingly, ranking module 106 may optionally rank such a profile content channel highest among the ranking performed at step 120.

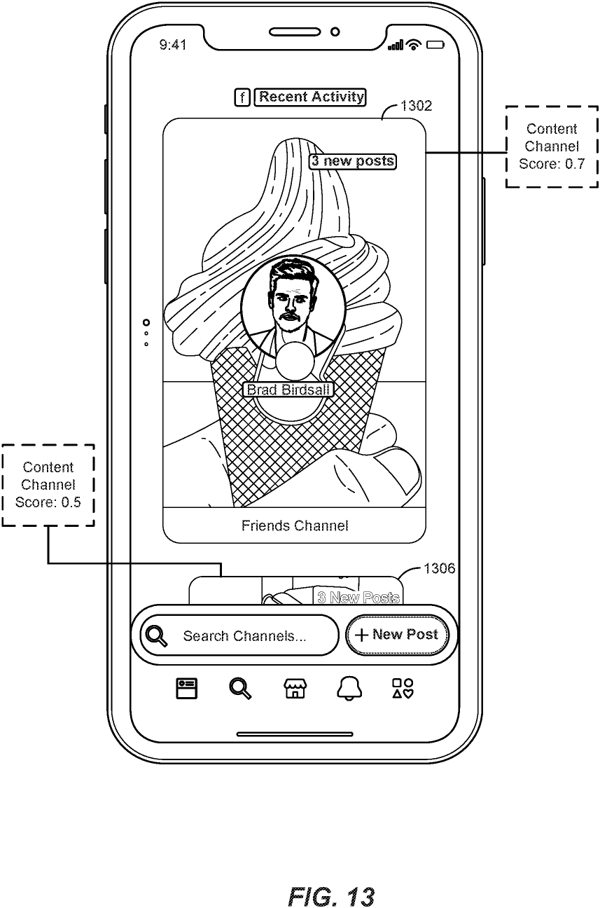

In view of the above, FIG. 13 shows a modified version of the embodiment of FIG. 9 (corresponding to the channel feed view with a prominent channel card for the “Brad Birdsall” content channel). In this modified embodiment, channel card 1302 may designate a corresponding content channel, such as a profile content channel for “Brad Birdsall.” Furthermore, FIG. 13 also illustrates how the corresponding content channel for channel card 1302 has been assigned a score of 0.7 by ranking module 106. Ranking module 106 may have assigned this score based on any one or more factors, such as background items of contextual information, which are discussed in more detail below in the context of step 120 of method 100. Although FIGS. 13-15 use illustrative examples of scores along a 0.0-1.0 scale, the use of the specific scale is merely optional, and the reader may ascertain that any suitable numerical or mathematical scale may be used when calculating scores or otherwise ranking content channel items.

Moreover, FIG. 13 also helpfully illustrates how an additional content channel, corresponding to a channel card 1306 has received a content channel score of 0.5. Accordingly, display module 108 may display channel card 1302 in an order indicating a higher priority for channel card 1302 (e.g., arriving earlier within a swiping sequence, or otherwise displayed with a higher level of prominence or priority) than for channel card 1306, as discussed in more detail below regarding step 130 of method 100. Furthermore, as further discussed above, in the case that the content channel for channel card 1302 corresponds to a profile content channel for the user account of “Brad Birdsall,” then the channel score of 0.7 may actually be the highest among the ranking of a multitude of content channels, including the content channels for channel card 1302 and for channel card 1306, as well as other channel cards that are not necessarily visible in FIG. 13.

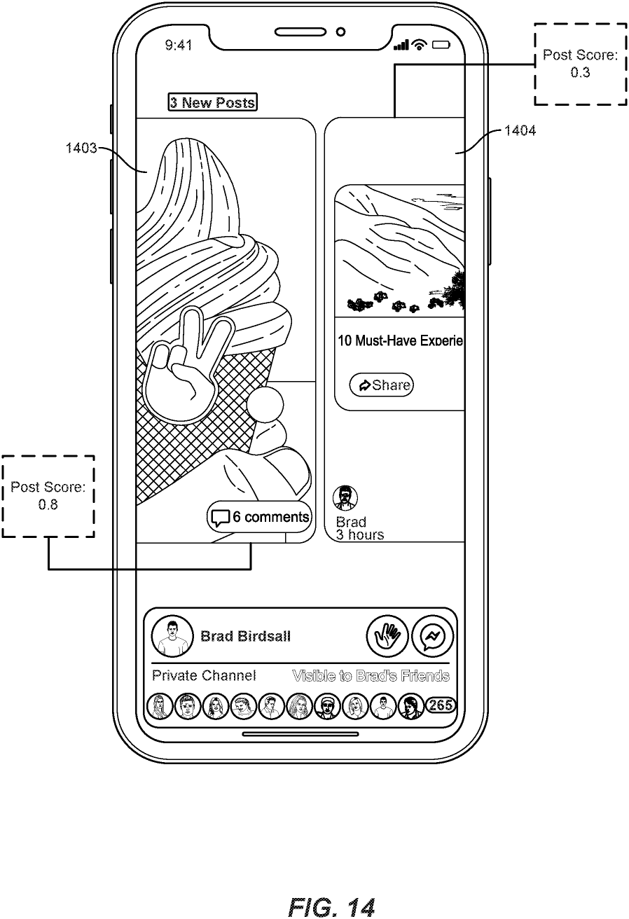

In addition to the example of ranking content channels themselves, as illustrated in FIG. 13, FIG. 14 provides an additional and/or alternative embodiment in which ranking module 106 may rank separate items of social network media content, such as items of social network media content 224 shown in FIG. 2. FIG. 14 may correspond to a modified version of the embodiment of FIG. 10, as further discussed above, and in this example the items of social network media content may correspond to posts within the online social network environment, such as a post 1403 and a post 1404 (which may parallel post 1003 and post 1004 that are shown in FIG. 10). As further discussed above, the parallel embodiments of FIG. 10 and FIG. 14 may show items of social network media content that are included internally within a single content channel, in this case the same content channel for channel card 1302 and user account “Brad Birdsall” that are discussed above in connection with FIG. 9 and FIG. 13. Moreover, the example embodiment of FIG. 14 further highlights how ranking module 106 additionally, or alternatively, ranks items of social network media content, such as post 1403 and/or post 1404, as distinct from ranking content channels themselves, which was previously illustrated in the example of FIG. 13.

As further discussed above in connection with FIGS. 9 and 10, display module 108 may optionally display internal posts, or other items of social network media content, within a single selected content channel, such as the content channel for “Brad Birdsall” in the graphical user interface of FIGS. 10 and 14 upon the user selecting, toggling, and/or tapping a corresponding graphical designator for the content channel, such as channel card 902 of FIG. 9 and channel card 1302 of FIG. 13. More specifically, FIG. 14 further illustrates how ranking module 106 may optionally score post 1403 with a post score of 0.8 and score post 1404 with a post score of 0.3. In a parallel manner to how display module 108 displayed the channel cards of FIG. 13 in an order corresponding to the corresponding channel scores, as well as the ranking resulting from these calculated scores display module 108 may also display the posts of FIG. 14 in an order corresponding to their post scores (e.g., with post 1403 having a relatively higher score and, therefore, being posted earlier and/or more prominently than post 1404 in this example).

Additionally, or alternatively, in some examples ranking module 106 may rank the content channel among other content channels by ranking content channels with at least one instance of unconsumed content higher than content channels with all previously consumed content. In other words, ranking module 106 may rank content channels with at least some unconsumed content higher than other content channels that a browsing user account has already consumed or viewed. In more specific examples, ranking module 106 may optionally restrict the consideration of consumed content to consumption of ephemeral stories within the online social network environment, as discussed in more detail below.

Moreover, in additional or alternative examples, ranking module 106 may also rank the content channel among other content channels by ordering a tail section of the ranking chronologically. In other words, in these examples, after performing one or more of the (i) profile content channel ranking and/or (ii) consumed-versus-unconsumed channel ranking procedures outlined above, ranking module 106 may further rank (iii) a remaining tail section of content channels chronologically (e.g., in a chronological order of time indicators associated with each content channel, such as the timing of creating these respective content channels and/or the timing of most recent updates or additions to these content channels). Of course, in some examples ranking module 106 may optionally perform any suitable permutation of two or more of the ranking procedures (i)-(iii) outlined above, including performing all three of these ranking procedures, thereby ordering the ranking of content channels as follows: the profile content channel highest, followed by content channels having some unconsumed content, followed by content channels having no unconsumed content, and/or followed by a remaining tail section of content channels in chronological order.

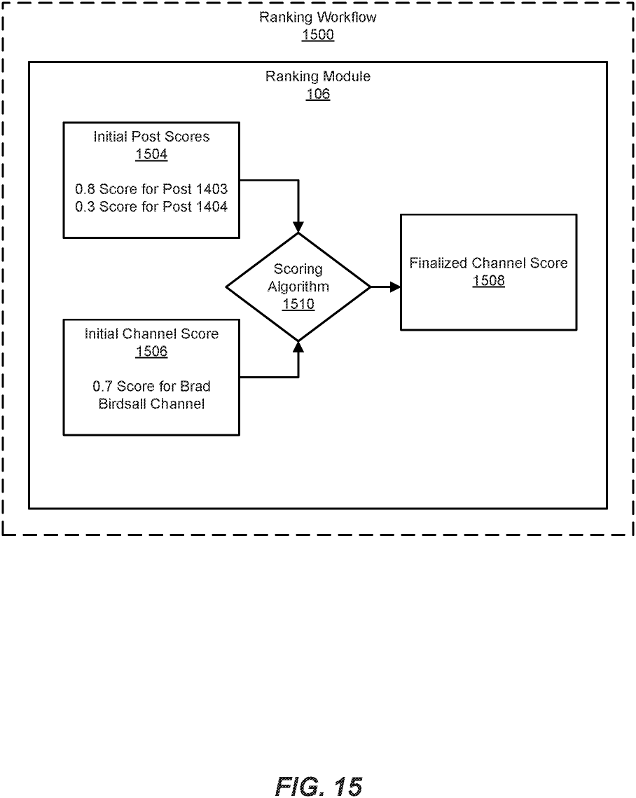

In additional examples, ranking module 106 may also separately and independently calculate both (i) an initial score for the content channel and (ii) initial scores for one or more items of social network media content within the content channel. Returning to the examples of FIG. 13 and FIG. 14, the content channel score for the content channel highlighted in FIG. 13 as well as the post scores shown in FIG. 14 may in some embodiments represent initial scores, which serve as input factors into an algorithm for calculating a finalized score for the same content channel. Moreover, in even further specific examples, ranking module 106 may optionally calculate a finalized score for the content channel as a function of the initial score for the content channel and the initial scores for the items of social network media content within the content channel. Accordingly, FIG. 15 further illustrates an example workflow 1500, in which ranking module 106 may receive initial post scores 1504 (corresponding to the post scores illustrated in FIG. 14) and initial channel score 1506 (corresponding to the channel score illustrated in FIG. 13) as input factors into a scoring algorithm 1510, which thereby produces an output in the form of a finalized channel score 1508 for the same content channel for the user account of “Brad Birdsall.” Of course, in this example initial post scores 1504 only include two separate post scores for two posts shown in FIG. 14, but in other examples initial post scores 1504 may include a large multitude of different post scores. Furthermore, because initial post scores 1504 may include different records for multiple items of social network media content internal to the same content channel, initial post scores 1504 may effectively constitute a vector (e.g., a two-dimensional mathematical vector) data structure for reference by ranking module 106.

In some specific examples, scoring algorithm 1510 may correspond to the maximum of any score from initial post scores 1504 and initial channel score 1506 (e.g., “MAX(CONTENT-CHANNEL-SCORE, STORY-1_SCORE, [...], STORY-N_SCORE)”). Alternatively, in other examples, scoring algorithm 1510 may correspond to the maximum of these same values, whereby these values are previously divided by a corresponding median value (e.g., “MAX(CONTENT-CHANNEL-SCORE/MEDIAN-CONTENT-CHANNEL-SCORE, STORY-1_SCORE/MEDIAN-STORY-SCORE, [...], STORY-N_SCORE/MEDIAN-STORY-SCORE)”).

In some example embodiments corresponding to FIG. 15, ranking module 106 may receive initial channel score 1506 from a stories aggregator for the online social network environment. In these examples, the stories referenced by the stories aggregator may correspond to (relatively short) user-generated photo and video collections, which optionally may be viewed up to a predetermined number of times (e.g., a predetermined limit of two times) and/or which may also optionally disappear after a predetermined period of time (e.g., disappear after 24 hours). In other examples, the stories aggregator may correspond more broadly to a multimedia content aggregator that references items of social network media content, such as photos, videos, and/or status updates, without one or more of the specific ephemeral features that are listed above. Similarly, ranking module 106 may optionally receive initial post scores 1504 from a news feed aggregator, or other aggregator, within the same online social network environment.

In further examples, ranking module 106 may also rank the content channel items based on at least one background item of contextual information. For example, ranking module 106 may rank the content channel items at least in part by prioritizing content channel items that originated from a friend of the user account within the online social network environment. In even further examples, ranking module 106 may prioritize content channel items originating from the friend of the user account at least in part by determining that the friend of the user account satisfies a nearness threshold within a social graph of the user account within the online social network environment. In other words, although a specific user account may possess a large number (e.g., hundreds) of bidirectional or other friends or contacts within the online social network environment, at least some of these contacts may be much more closely associated with the user account then other contacts in the user account’s friend list. For example, some of these other contacts may simply correspond to mere acquaintances. Moreover, information helping to identify close friends and relatives of the user account, as distinguished from less close acquaintances, may be extracted from a social graph for the user account within the online social network environment. For example, the social graph may be based on indications of genetic relatedness, measurements of unidirectional or bidirectional contact and exchanges between the user account and other contacts, measurements of liking and/or approving, by one party, items of social media content uploaded or shared by another party, etc.

Additionally, or alternatively, in some examples ranking module 106 may rank the content channel items based at least in part on a background item of contextual information including an indication of a subject matter preference of the user account. For example, the user account may have a particular indicated preference for a certain item of popular culture, a certain religious view, a certain political view, a certain topic (e.g., puppies or rainbows), and/or a certain charitable cause (e.g., cancer treatment research). Of course, these listed examples are merely illustrative. Moreover, in some examples ranking module 106 may further extract one or more items of information indicating such preferences by the user account based at least in part on a semantic analysis of content input by the user account into the online social network environment. For example, ranking module 106 may optionally perform a semantic analysis of one or more posts or messages submitted by the user account, and the semantic or textual analysis of this information may further reveal the corresponding preference, as further discussed above. Furthermore, in other examples ranking module 106 may also rank the content channel items based on at least one background item of contextual information that includes recency information, such that ranking module 106 ranks more recent content channel items higher than less recent content channel items (e.g., more recently created content channels higher than less recently created content channels and/or more recently created posts to content channels higher than other less recently created posts).

Returning to FIG. 1, at step 130, one or more of the systems described herein may display the content channel items to the user account in an order corresponding to the ranking. For example, as illustrated in FIG. 3, at step 130 display module 108 may display the content channel items corresponding to content channel 222 and/or items of social network media content 224 to the user account at computing device 302 in an order corresponding to the ranking performed at step 120, as further discussed above.

Display module 108 may display the content channel items in the order corresponding to the ranking performed at step 120 in a variety of ways. In some examples, display module 108 may perform step 130 directly when display module 108 is located at computing device 302 (e.g., as part of local client social network application 350). Additionally, or alternatively, display module 108 may be located at server 306 and may thereby perform step 130 by instructing or commanding, or otherwise initiating, the display of information at computing device 302 from across the network connection shown in FIG. 3. In other words, in some examples a backend server of an online social network environment may effectively display items of information at a display of a client-side computing device by transmitting these items of information to the client-side computing device and thereby triggering client-side display of this information.

In some examples, display module 108 may display the content channel items in a sequential order over time. Returning to the example of FIG. 9, display module 108 may display channel card 902 prior to displaying channel card 906. Additionally, or alternatively, display module 108 may display channel card 902 in a two-dimensional directional order indicating a higher priority for channel card 902 in comparison to channel card 906 (e.g., because the user may swipe or drag corresponding channel cards in a direction that reveals subsequent channel cards, whereby the subsequent channel cards are indicated as having a comparatively lower priority and, for this reason, are displayed relatively later than higher priority channel cards). In other words, the sequence of the content channel may correspond to a chronological sequence for displaying items of social network media content over time and/or a sequence for laying out multiple items of social network media content within a single display, as further discussed above.

Similarly, or alternatively, once a browsing user account has entered into a channel overview embodiment, which may correspond to the example of FIG. 10, display module 108 may display one or more posts, or other items of social media content contained within the corresponding content channel, in an order indicating a higher level of priority than one or more of the remaining posts. In the example of FIG. 10, display module 108 may optionally display post 1003 in an order indicating a higher level of priority for post 1003 than for post 1004. Again, this order may correspond to a right-to-left direction in which a user may drag or swipe, or otherwise manipulate, these posts to thereby reveal subsequent posts, whereby the earlier posts are indicated as having a higher level of priority or urgency for displaying to the user than the subsequent posts. Additionally, of course the vice versa direction of left-to-right (and/or vertical scrolling directions) may also optionally be used in other embodiments. Of course, in all of these examples the order for displaying the content channel items may be based on one or more scores calculated by ranking module 106 at step 120, as further discussed above.

Furthermore, display module 108 may also use one or more other factors for highlighting a higher level of priority for one instance of content channel items in comparison to another instance. For example, display module 108 may display a higher priority content channel item in a larger size than a lower priority content channel item. Similarly, display module 108 may optionally display a higher priority content channel item using a higher level of highlight, vividness, distractibility, motion, and/or other visual or multimedia feature, thereby signaling to a browsing user account that the higher priority content channel item is relatively higher in importance or priority (e.g., in terms of a recommendation system ranking these items at step 120) than one or more remaining content channel items.

The instant disclosure describes various systems and methods for ranking channel content. In one example, a computer-implemented method may include (i) maintaining, within an online social network environment, a content channel that defines both (a) which user accounts within the online social network environment have access to the content channel and (b) a sequence for displaying items of social network media content to a user account viewing the content channel, (ii) ranking content channel items by calculating scores for the content channel items indicating an estimated level of priority for displaying the content channel items to the user account, the ranking including at least one of (a) ranking the content channel among at least one other content channel or (b) ranking the items of social network media content within the content channel, and (iii) displaying the content channel items to the user account in an order corresponding to the ranking.

In some examples, ranking the content channel among at least one other content channel may include ranking a profile content channel for the user account as having a highest rank among the ranking. In further examples, ranking the content channel among at least one other content channel may include ranking content channels with at least one instance of unconsumed content higher than content channels with all previously consumed content. Additionally, in some examples, ranking the content channel among at least one other content channel may include ordering a tail section of the ranking chronologically.

Furthermore, in some examples, the online social network environment separately and independently calculates (i) an initial score for the content channel and (ii) initial scores for the items of social network media content within the content channel. Moreover, in some of these examples, the online social network environment calculates a finalized score for the content channel as a function of both the initial score for the content channel and the initial scores for the items of social network media content within the content channel.

Additionally, in further examples ranking the content channel items by calculating scores for the content channel items indicating the estimated level of priority for displaying the content channel items to the user account further includes ranking the content channel items based on at least one background item of contextual information. In some examples, ranking the content channel items based on the background item of contextual information may include prioritizing content channel items that originated from a friend of the user account within the online social network environment. In further examples, prioritizing content channel items that originated from the friend of the user account within the online social network environment includes determining that the friend of the user account satisfies a nearness threshold within a social graph of the user account within the online social network environment. Additionally, in some examples, the background item of contextual information may include an indication of a subject matter preference of the user account. Furthermore, in some of these examples, the indication of the subject matter preference of the user account is based on a semantic analysis of content input by the user account into the online social network environment. Moreover, in some examples, ranking the content channel items based on at least one background item of contextual information includes ranking more recent content channel items higher than less recent content channel items.

In some examples, (i) the content channel includes a container within the online social network environment, (ii) the container within the online social network environment contains the items of social network media content for displaying in the sequence, and (iii) the items of social network media content contained within the container include a mixture of different types of social network media content. In some of these examples, the mixture of different types of social network media content contained within the container includes a mixture of: (i) text-based status update posts, (ii) photograph-based posts, and (iii) video-based posts.

In some embodiments, the online social network environment provides multiple content channels including the content channel. Moreover, in some of these examples, the online social network environment provides an interface for the user account to (i) scroll through graphical elements respectively indicating the multiple content channels and (ii) select the content channel from among the multiple content channels by interacting with a respective one of the graphical elements. Additionally, in some examples, each one of the multiple content channels includes a respective separate and independent notifications feed within the online social network environment. Furthermore, in some examples, the online social network environment enables the user account to select the content channel as the respective separate and independent notifications feed instead of providing the user account with a single global notifications feed.

In some embodiments, the online social network environment, upon a creating user account attempting to create the content channel, requests for the creating user account to specify which user accounts within the online social network environment have access to the content channel. Additionally, in some examples, the online social network environment receives an indication from a creating user account of which user accounts within the online social network environment have access to the content channel.

In one embodiment, a system for implementing the above-described method may include (i) a maintenance module, stored in memory, that maintains, within an online social network environment, a content channel that defines both (a) which user accounts within the online social network environment have access to the content channel and (b) a sequence for displaying items of social network media content to a user account viewing the content channel, (ii) a ranking module, stored in memory, that ranks content channel items by calculating scores for the content channel items indicating an estimated level of priority for displaying the content channel items to the user account, the ranking including at least one of (a) ranking the content channel among at least one other content channel or (b) ranking the items of social network media content within the content channel, (iii) a display module, stored in memory, that displays the content channel items to the user account in an order corresponding to the ranking, and (iv) at least one physical memory configured to execute the maintenance module, the ranking module, and the display module.

In some examples, the above-described method may be encoded as computer-readable instructions on a non-transitory computer-readable medium. For example, a computer-readable medium may include one or more computer-executable instructions that, when executed by at least one processor of a computing device, may cause the computing device to (i) maintain, within an online social network environment, a content channel that defines both (a) which user accounts within the online social network environment have access to the content channel and (b) a sequence for displaying items of social network media content to a user account viewing the content channel, (ii) rank content channel items by calculating scores for the content channel items indicating an estimated level of priority for displaying the content channel items to the user account, the ranking including at least one of (a) ranking the content channel among at least one other content channel or (b) ranking the items of social network media content within the content channel, and (iii) display the content channel items to the user account in an order corresponding to the ranking.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

The term “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
maintaining, within an online social network environment, a plurality of content channels where each of the plurality of content channels defines both:
which user accounts within the online social network environment have access to the content channel; and
a sequence position for displaying the content channel among the plurality of content channels to a user account;
ranking each of the plurality of content channels based on content channel items within each of the plurality of content channels by calculating scores for the content channel items indicating an estimated level of priority for displaying the content channel items to the user account,
wherein ranking each of the plurality of content channels comprises calculating a combined score for each of the plurality of content channels as a function of both an initial score assigned to the content channel and initial scores assigned to items of social network media content within the content channel, and calculating the combined score comprises executing a scoring algorithm that assigns the combined score to the content channel as a maximum score within a set of scores that includes an initial score assigned to the content channel and initial scores assigned to items of social networking media content within the content channel;
modifying, for each of the plurality of content channels, the sequence position for displaying the content channel based on the ranking associated with the content channel; and
displaying the plurality of content channels according to the modified sequence positions.

2. The computer-implemented method of claim 1, wherein ranking each of the plurality of content channels further comprises ranking a profile content channel for the user account as having a highest rank.

3. The computer-implemented method of claim 1, wherein ranking each of the plurality of content channels further comprises ranking content channels with at least one instance of unconsumed content higher than content channels with all previously consumed content.

4. The computer-implemented method of claim 1, wherein a ranking module receives the initial score from a stories aggregator for the online social network environment.

5. (canceled)

6. The computer-implemented method of claim 1,
further comprising dividing each score in the set of scores by corresponding median value; and
wherein the scoring algorithm is executed after dividing each score within the set by the corresponding median value.

7. The computer-implemented method of claim 1, further comprising calculating scores for the content channel items based on at least one background item of contextual information.

8. The computer-implemented method of claim 7, wherein calculating scores for the content channel items further comprises prioritizing content channel items that originated from a friend of the user account within the online social network environment.

9. The computer-implemented method of claim 8, wherein prioritizing content channel items that originated from the friend of the user account within the online social network environment further comprises determining that the friend of the user account satisfies a nearness threshold within a social graph of the user account within the online social network environment.

10. The computer-implemented method of claim 7, wherein the at least one background item of contextual information comprises an indication of a subject matter preference of the user account.

11. The computer-implemented method of claim 10, wherein the indication of the subject matter preference of the user account is based on a semantic analysis of content input by the user account into the online social network environment.

12. The computer-implemented method of claim 7, wherein calculating scores for the content channel items based on at least one background item of contextual information comprises scoring more recent content channel items higher than less recent content channel items.

13. The computer-implemented method of claim 1, wherein:
each of the plurality of content channels comprise a container within the online social network environment;
the container within the online social network environment contains the items of social network media content for displaying in a corresponding content channel sequence; and
the items of social network media content contained within the container for each of the plurality of content channels include a mixture of different types of social network media content.

14. The computer-implemented method of claim 13, wherein the mixture of different types of social network media content contained within the container for each of the plurality of content channels includes a mixture of:
text-based status update posts;
photograph-based posts; and
video-based posts.

15. The computer-implemented method of claim 1, wherein:
the online social network environment provides an interface for the user account to:
scroll through graphical elements respectively indicating the plurality of content channels; and
select a content channel from among the plurality of content channels by interacting with a respective one of the graphical elements.

16. The computer-implemented method of claim 15, wherein:
each one of the plurality of content channels includes a respective separate and independent notifications feed within the online social network environment; and
the online social network environment enables the user account to select the content channel as the respective separate and independent notifications feed instead of providing the user account with a single notifications feed.

17. The computer-implemented method of claim 1, wherein the online social network environment, upon a creating user account attempting to create a content channel, requests for the creating user account to specify which user accounts within the online social network environment have access to the content channel.

18. The computer-implemented method of claim 17, wherein the online social network environment receives an indication from a creating user account specifying which accounts within the online social network environment have access to the content channel.

19. A system comprising:
a maintenance module, stored in memory, that maintains, within an online social network environment, a plurality of content channels that-defines both:
which user accounts within the online social network environment have access to the content channel; and
a sequence position for displaying the content channel among the plurality of content channels to a user account;
a ranking module, stored in memory, that:
ranks each of the plurality of content channels based on content channel items within each of the plurality of content channels by calculating scores for the content channel items indicating an estimated level of priority for displaying the content channel items to the user account, and
modifies, for each of the plurality of content channels, the sequence position for displaying the content channel based on the ranking associated with the content channel;
a display module, stored in memory, that displays the plurality of content channels according to the modified sequence positions; and
at least one physical memory configured to execute the maintenance module, the ranking module, and the display module;
wherein ranking each of the plurality of content channels comprises calculating a combined score for each of the plurality of content channels as a function of both an initial score assigned to the content channel and initial scores assigned to the items of social network media content within the content channel, and calculating the combined score comprises executing a scoring algorithm that assigns the combined score to the content channel as a maximum score within a set of scores that includes the initial score assigned to the content channel and the initial scores assigned to items of social networking media content within the content channel.

20. A non-transitory computer-readable medium comprising one or more computer-readable instructions that, when executed by at least one processor of a computing device, cause the computing device to:
maintain, within an online social network environment, a plurality of content channels where each of the plurality of content channels that both:
which user accounts within the online social network environment have access to the content channel; and
a sequence position for displaying the content channel among the plurality of content channels to a user account;
rank each of the plurality of content channels based on content channel items within each of the plurality of content channels by calculating scores for the content channel items indicating an estimated level of priority for displaying the content channel items to the user account,
wherein ranking each of the plurality of content channels comprises calculating a combined score for each of the plurality of content channels as a function of both an initial score assigned to the content channel and initial scores assigned to the items of social network media content within the content channel, and calculating the combined score comprises executing a scoring algorithm that assigns the combined score to the content channel as a maximum score within a set of scores that includes the initial score assigned to the content channel and the initial scores assigned to items of social networking media content within the content channel;
modify, for each of the plurality of content channels, the sequence position for displaying the content channel based on the ranking associated with the content channel; and
display the plurality of content channels according to the modified sequence positions.

21. The system of claim 19, wherein the ranking module further ranks each of the plurality of content channels by ranking a profile content channel for the user account as having a highest rank.

22. The system of claim 19, wherein the ranking module further ranks each of the plurality of content channels by ranking content channels with at least one instance of unconsumed content higher than content channels with all previously consumed content.
